(19) United States
(12) Patent Application Publication
(10) Pub. No.: US 2007/0186730 A1
(43) Pub. Date: Aug. 16, 2007

(54) Extensible handle for a hand tool

(76) Inventor: Chia-Yu Chen, Taichung City (TW)

Correspondence Address: TROXELL LAW OFFICE PLLC, SUITE 1404, 5205 LEESBURG PIKE, FALLS CHURCH, VA, 22041, US

(21) Appl. No.: 11/354,844

(22) Filed: Feb. 16, 2006

(51) Int. Cl. B25B 23/16; B25G 1/04

(52) U.S. Cl. 81/177.2

(57) ABSTRACT

An extensible handle for a hand tool includes a main body, a sleeve and a rotator. The main body has an extension bar provided with plural locking ball holes. The sleeve matched with the extension bar is provided pivotally with a ball corresponding with the locking ball holes. The rotator restrictively and pivotally matched with the front portion of the sleeve is provided with a releasing groove corresponding with the ball. When the releasing groove is moved to coincide with the ball, the extension bar can reciprocate freely along the sleeve. On the contrary, when the releasing groove is moved to separate from the ball, the ball is to be confined in the locking ball hole, keeping the extension bar restricted and immovable.

### BACKGROUND OF THE INVENTION

1. Field of the Invention

This invention relates to an extensible handle for hand tool, particularly to one that a sleeve can move fro and to along an extension bar via controlling a rotator.

2. Description of the Prior Art

A conventional hand tool 10, as shown in FIG. 1, disclosed in a U.S. Pat. No. 6,408,721 B1, includes mainly a main body 11, a sleeve 12 and an adjusting member 13. The main body 11 is provided axially with plural annular slots 111. The adjusting member 13 assembled between the sleeve 12 and the main body 11 is provided with a fixing ball 131 to correspondingly lock with the annular slots 111 of the main body 11. When the adjusting member 13 is to be displaced on the main body 11, the adjusting member 13 has to be forced axially to release the fixing ball 131, so that the ring slot 111 is freed from restricted by the fixing ball 131, enabling the sleeve 12 to move freely for adjusting a suitable length. And, as the length is adjusted to the desired, the axial force can be stopped and the adjusting member 13 is returned to the original position so as to keep the fixing ball 131 locked restrictively with the annular slot 111.

But, in practice, when the fixing ball 131 is locked in the annular slot 111, it is to carry out an axial rotation that is apt to let the sleeve 12 rotate while using the hand tool 10, causing a difficulty for operating the main body 11. Moreover, the adjusting member 13 must be forced axially and continuously while adjusting the length of the main body 11, causing an inconvenience for operation.

### SUMMARY OF THE INVENTION

The objective of this invention is to offer an extensible handle for hand tool.

The main characteristics of the invention are a main body, a sleeve and a rotator. The main body has an extension bar jointed at the end. The extension bar is provided with a preset number of locking ball holes. Every two of the locking ball holes adjacent are linked together by a slot. The sleeve formed cylindrical is provided with a matching hole for matching with the extension bar and a ball hole at a preset position of the outer surface for fitting correspondingly a ball able to be restricted correspondingly in the locking ball holes. The rotator formed as a ring is provided with a penetrating hole for matching with the sleeve to keep the rotator restricted pivotally at the front portion of the sleeve. The penetrating hole is provided with a releasing groove on the inner surface, corresponding with the ball. When the releasing groove is moved to coincide with the ball, the ball is able to move axially to and fro, enabling the extension bar to reciprocate freely along the sleeve. On the contrary, when the releasing groove is moved to separate from the ball, the ball limited by the inner surface of the penetrating hole is to be confined in the locking ball hole, keeping the main body restricted and immovable, contributing a good effect of fixing without any other unexpected whirling or displacement.

### BRIEF DESCRIPTION OF DRAWINGS

This invention is better understood by referring to the accompanying drawings, wherein:

FIG. 1 is a cross-sectional view of a fixing mechanism of a conventional hand tool;

FIG. 2 is a perspective view of a first preferred embodiment of an extensible handle for a hand tool in the present invention;

FIG. 3 is an exploded perspective view of the first preferred embodiment of an extensible handle for a hand tool in the present invention;

FIG. 4 is an axial cross-sectional view of the first preferred embodiment of an extensible handle for a hand tool in the present invention, showing it being released and becoming able to move;

FIG. 5 is an axial cross-sectional view of the first preferred embodiment of an extensible handle for a hand tool in the present invention, showing it being restricted and unable to move;

FIG. 6 is a front cross-sectional view of the first preferred embodiment of an extensible handle for a hand tool in the present invention, showing it being restricted;

FIG. 7 is a perspective view of a second preferred embodiment of an extensible handle for a hand tool in the present invention;

FIG. 8 is an exploded perspective view of the second preferred embodiment of an extensible handle for a hand tool in the present invention;

FIG. 9 is a front cross-sectional view of the second preferred embodiment of an extensible handle for a hand tool in the present invention, showing it being restricted; and

FIG. 10 is an exploded perspective view of a third preferred embodiment of an extensible handle for a hand tool in the present invention.

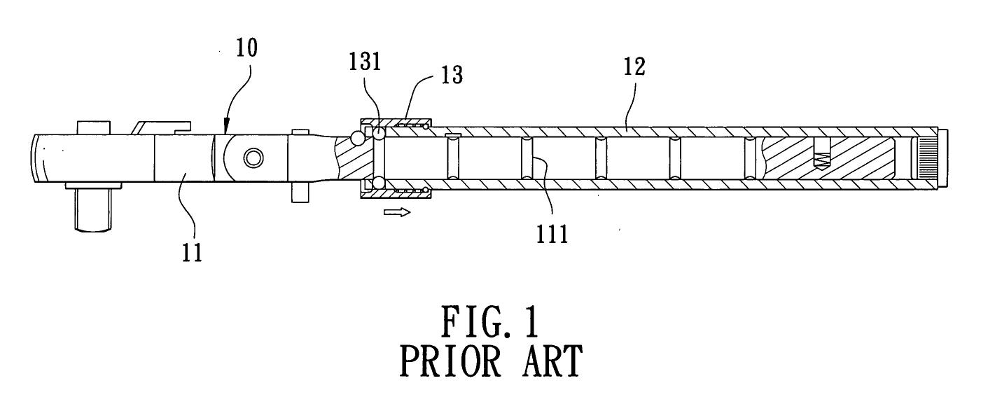

### DETAILED DESCRIPTION OF THE PREFERRED EMBODIMENT

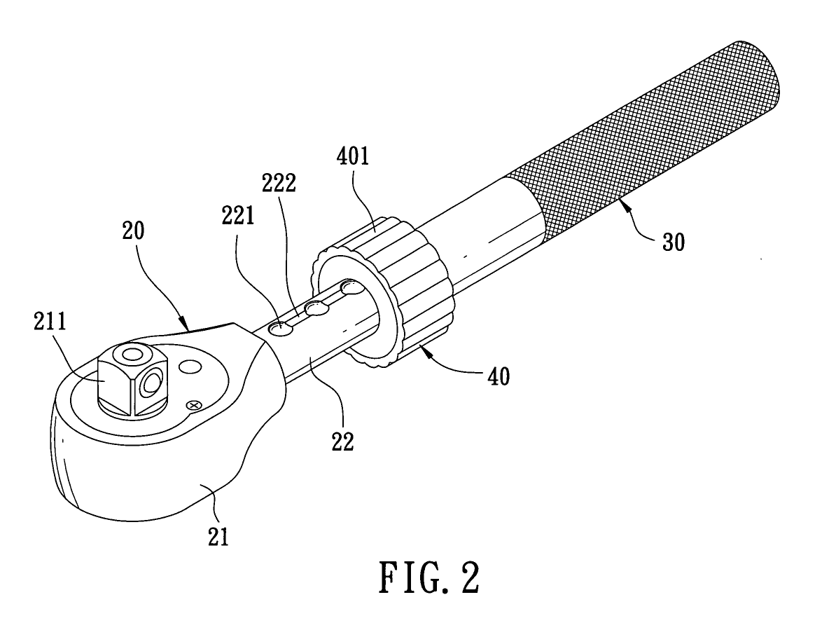

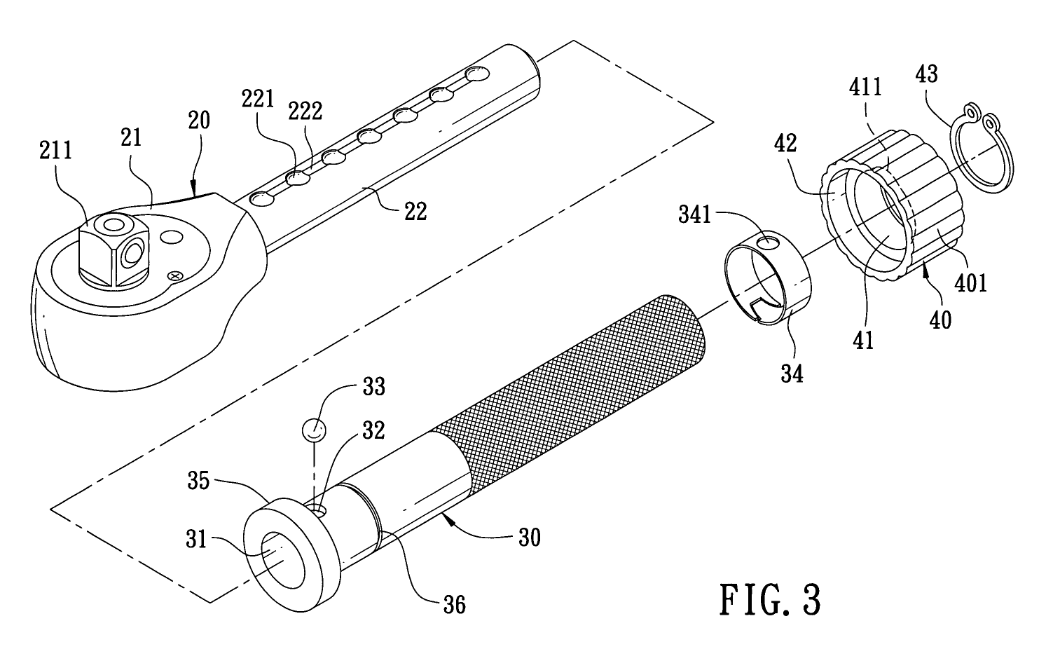

As shown in FIGS. 2 and 3, a first preferred embodiment of an extensible handle for a hand tool in the present invention includes a main body 20, a sleeve 30 and a rotator 40.

The main body 20 is provided with a working head 21 at the front, a ratchet 211 pivotally connected with the working head 21 for connecting pivotally with a working tool, and an extension bar 22 connected backward and formed integrally together with the working head 21. The extension bar 22 formed circular is provided with plural locking ball holes 221 located axially and spaced equidistantly. Every two of the locking ball holes 221 adjacent are linked together by a slot 222.

The sleeve 30 formed cylindrical is provided with a matching hole 31 axially at its center for matching with the extension bar 22 and a ball hole 32 on a preset location of the outer surface for aligning with the locking ball holes 221 of the extension bar 22. A ball 33 is to be confined in the ball hole 32, able to slide on the locking ball holes 221 and the slots 222 of the extension bar 22 while the sleeve 30 is moved to and fro along the extension bar 22. In addition, a round elastic annular plate 34 to be worn around the ball hole 32 is cut with a hole 341 having a diameter less than that of the ball 33, enabling the ball 33 to be elastically blocked in the elastic annular plate 34. Moreover, the sleeve 30 is also projected with a restrictive projected rim 35 at the front end and with an annular locking groove 36 at a preset position of the front portion.

The rotator 40 made of metal and shaped as a ring is provided with plural wave-shaped humps 401 around the outer surface for enhancing abrasion for operation, a penetrating hole 41 at the center for matching pivotally with the front portion of the sleeve 30 and a restrictive hole 42 recessed inwards at the front portion of the hole 41 to match with the projected rim 35. The hole 41 is provided with a releasing groove 411 axially, corresponding to the ball 33. In addition, the rotator 40 is matched with a C-locker 43 at the end for being correspondingly restricted in the locking groove 36 after the rotator 40 is matched with the sleeve 30, enabling the rotator 40 to be restricted around the sleeve 30.

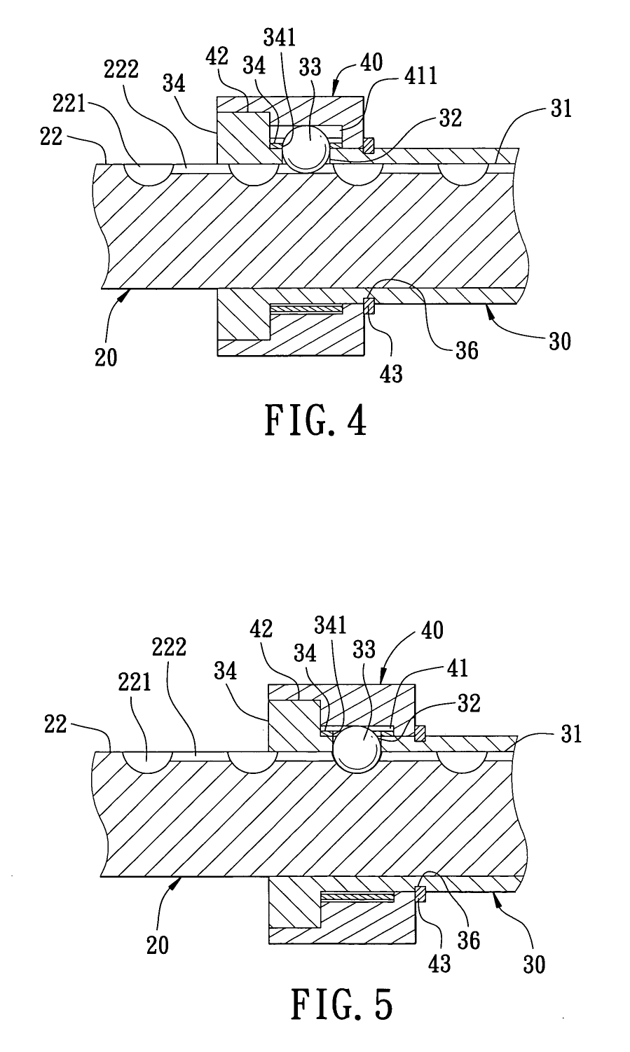

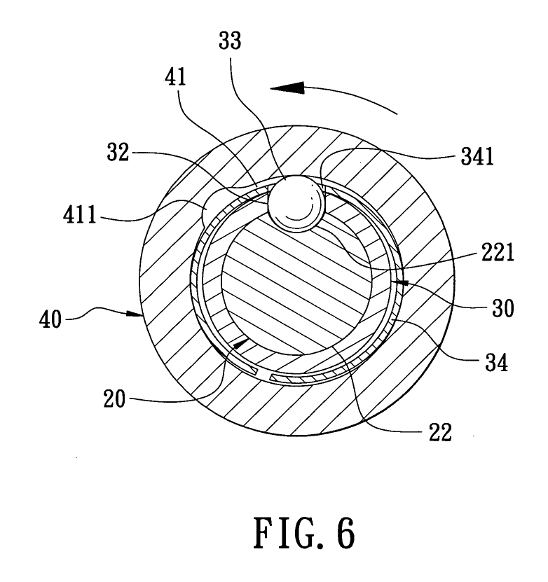

In using, as shown in FIG. 4, when the length of the main body 20 is to be adjusted, the rotator 40 has to be spun first to enable the releasing groove 411 of the hole 41 to coincide with the ball 33. So, the ball 33 confined in the releasing groove 411 is able to move along the path aligned by the locking ball holes 221 and the slot 222, so that the main body 20 can move freely to become a desired length along the sleeve 30. Next, as shown in FIGS. 5 and 6, after the length of the main body 20 has been adjusted to a desired one, the rotator 40 is again rotated to keep the releasing groove 411 of the hole 41 separated away from the ball 33. By the time, because the diameter of the inner ring of the hole 41 is smaller, the ball 33 is to be compressed by the inner portion of the hole 41 so as to be confined in the locking ball hole 221 of the main body 20, enabling the main body 20 to be fixed restrictively with the sleeve 30.

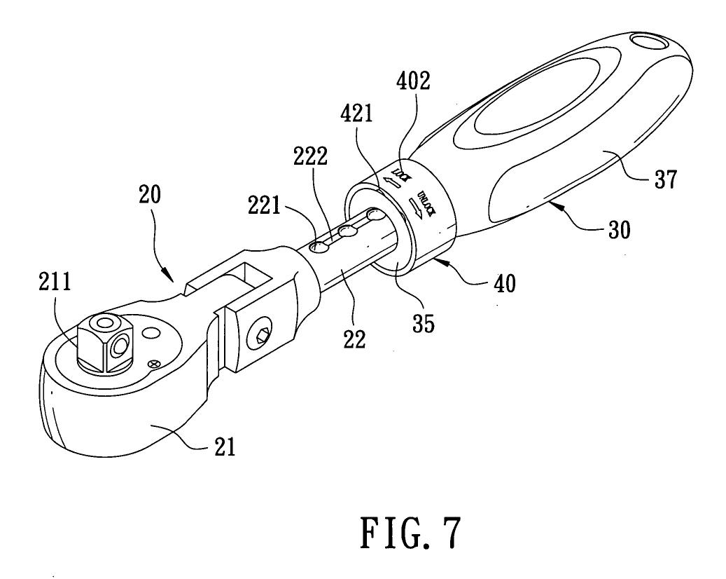

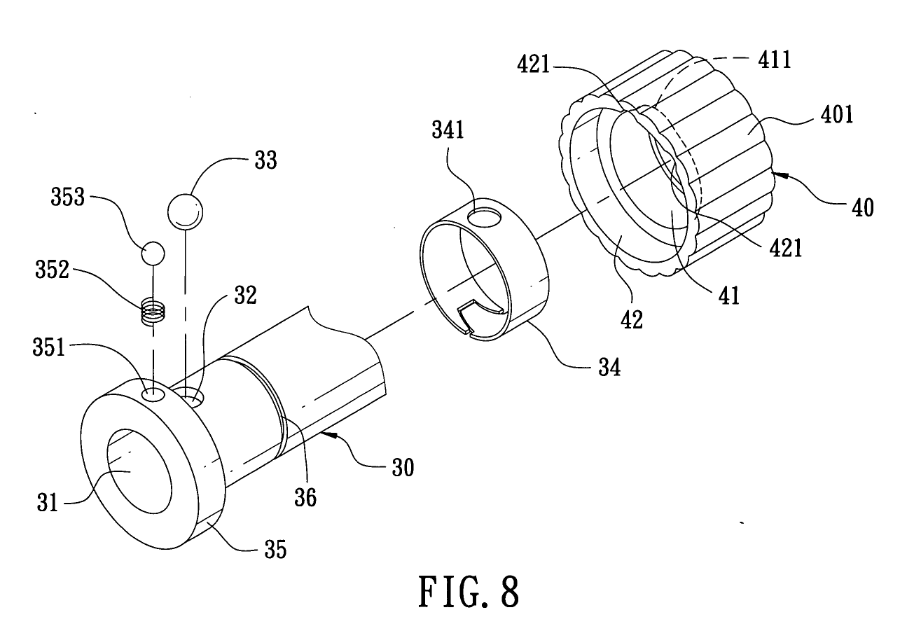

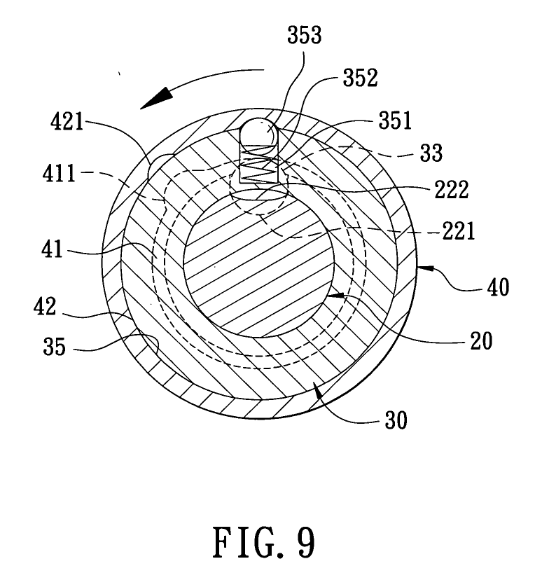

As shown in FIGS. 7, 8 and 9, a second preferred embodiment of an extensible bar for a hand tool in the present invention includes a main body 20, a sleeve 30 and a rotator 40 as the first preferred embodiment does. What are to be described below are the structure different from the first preferred embodiment.

The extension bar 22 is connected pivotally with the working head 21, so that the extension bar 22 and the working head 21 can be adjusted to have different angles preset previously.

The sleeve 30 is provided with a holder 37 at the end, which is formed integrally in a preset shape by injection molding. The holder 37 axially worn on the sleeve 30 is leaned to the end of the rotator 40 by its end, enabling the rotator 40 to be fixed with the sleeve 30 without needing a fixing component. Moreover, the shape of the holder 37 can be altered in accordance with the requirement of customers. The projected rim 35 is provided with a fixing hole 351 that is inserted with a spiral spring 352 and a fixing ball 353 orderly. So, the fixing ball 353 is, though, locked in the fixing hole 351, it bears an outward force coming from the spiral spring 352.

The rotator 40 can be made of plastics for sake of various alternations. The restrictive hole 42 is provided with two fixing recesses 421. One of the fixing recesses 421 is engaged axially with the releasing groove 411. And, when the fixing recess 421 is coincided with the fixing ball 353, the fixing ball 353 is to be locked in the fixing recess 421 owing to a force pushing it outwards by the spiral spring 352. Therefore, there are two fixing points on the rotator 40, enabling the rotator 40 to carry out positioning precisely and easily. Moreover, the rotator 40 is provided with marks 402 positioned corresponding with the fixing recesses 421 on the outer annular surface, helpful for a user to operate the rotator 40.

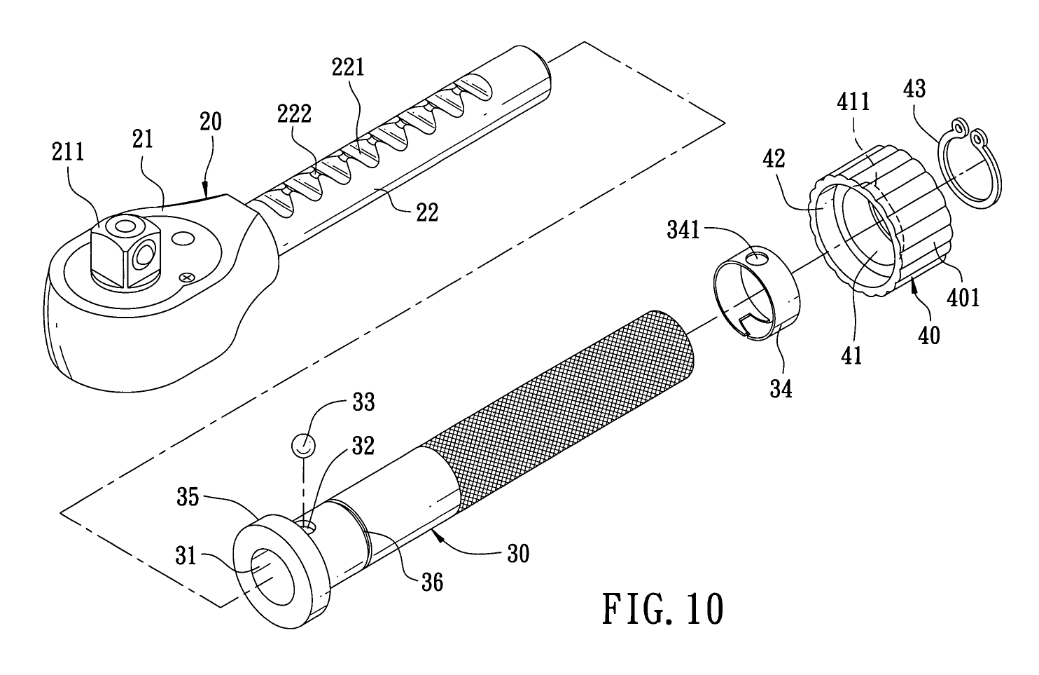

As shown in FIG. 10, a third preferred embodiment of an extensible bar for a hand tool in the present invention includes a main body 20, a sleeve 30 and a rotator 40 as the first preferred embodiment does. What is to be described below is the structure different from the first preferred embodiment.

The locking ball holes 221 on the extension bar 22 are connected successively without interval to form as a saw-teeth shape, so that the ball 33 falls into one of the locking ball holes 221 spontaneously while moving along the locking ball holes 221, enabling the main body 20 to move along the sleeve 30 in a constant displacement, keeping the rotator 40 easy to be fixed up.

The present invention has the following advantages as can be seen from the foresaid description.

1. The penetrating hole 41 of the rotator 40 can control the position of the ball 33 to keep the main body 20 able to freely move within the sleeve 30 or restrictively limited on a present position. In addition, the ball 33, after being confined in the locking ball hole 221 by the inner ring of the penetrating hole 41, can contribute a good fixing effect without any unexpected rotation or displacement while using the invention.

2. The rotator 40 and the sleeve 30 have very simple structures and are easy to be assembled together. Therefore, the present invention is very competitive because of low cost and short manufacturing time.

3. The sleeve 30 can be pressed with different pictures or textures and alternated with various handles.

While the preferred embodiment of the invention has been described above, it will be recognized and understood that various modifications may be made therein and the appended claims are intended to cover all such modifications that may fall within the spirit and scope of the invention.

What is claimed is:

1. An extensible handle for a hand tool comprising:
a main body provided with a working head at the front for connecting with a working tool and an extension bar jointed behind said working head, said extension bar provided axially with a preset number of locking ball holes on the outer surface, every two adjacent of said locking ball holes communicated by a slot;
a sleeve provided axially with a matching hole for said main body to pierce through, a ball hole on a preset position and a projected rim at the front end, said ball hole able to accept a ball therein, said ball able to be restrictively locked in one of said locking ball holes of said main body;
a rotator shaped as a ring and provided with a penetrating hole to wear pivotally and restrictively on the front end of said sleeve, said penetrating hole having a restrictive hole with a larger diameter at the front, able to keep said rotator restricted with said projected rim of said sleeve, a releasing groove provided on the inner surface of said penetrating hole and corresponding with said ball of said sleeve; and
said main body able to move axially along said sleeve to and fro when said releasing groove of said rotator coincides with said ball; said ball to be restricted by an inner ring of said penetrating hole so as to be locked in said locking ball hole.

2. An extensible handle for a hand tool as claimed in claim 1, wherein said projected rim of said sleeve is provided with a fixing hole at a preset position to be inserted with a spiral spring 352 and a fixing ball 353 orderly. The diameter of said fixing ball is bigger than that of said fixing hole, enabling said spiral spring and said fixing ball to be restricted in said fixing hole, said fixing ball can reciprocate axially because it bears an outward force from said spiral spring, said restrictive hole is provided with two fixing recesses on the inner surface, corresponding with said fixing ball, and one of said fixing recesses is engaged axially with said releasing groove.

3. An extensible handle for a hand tool as claimed in claim 1, wherein said ball hole of said sleeve is worn with an elastic ring plate that is pierced with a hole corresponding with said ball hole. Said hole has a diameter less than that of said ball hole so that said ball is to be restricted elastically in said elastic ring plate.

4. An extensible handle for a hand tool as claimed in claim 1, wherein said locking ball holes are linked successively without interval, forming as a saw-teeth shape.

5. An extensible handle for a hand tool as claimed in claim 1, wherein said sleeve is covered by a holder that is leaned to the end of said rotator by its front end, contributing an effect of automatic restriction.

6. An extensible handle for a hand tool as claimed in claim 1, wherein said sleeve is provided with a locking groove at the end of said rotator for engaging with a C-locker so as to keep said C-locker restricted at the front end of said sleeve.

7. An extensible handle for a hand tool as claimed in claim 1, wherein said rotator is made of metal.

8. An extensible handle for a hand tool as claimed in claim 1, wherein said rotator is made of plastics.

9. An extensible handle for a hand tool as claimed in claim 1, wherein said rotator is provided with plural wave-shaped humps on the outer surface for enhancing abrasion for operation.

10. An extensible handle for a hand tool as claimed in claim 1, wherein said rotator is provided with marks on the outer surface.
